(19) United States
(12) Patent Application Publication
(10) Pub. No.: US 2008/0192042 A1
(43) Pub. Date: Aug. 14, 2008

(54) Circuit for Generating Driving Voltages, Display Device Using the Same, and Method of Generating Driving Voltages

(76) Inventors: Jong-Seok Chae, Seoul (KR); Seong-Jae Yoon, Suwon-si (KR)

Correspondence Address: F. CHAU & ASSOCIATES, LLC, 130 WOODBURY ROAD, WOODBURY, NY, 11797, US

(21) Appl. No.: 11/925,445

(22) Filed: Oct. 26, 2007

(30) Foreign Application Priority Data
Feb. 9, 2007 (KR) 10-2007-0013561

(51) Int. Cl. G09G 5/00

(52) U.S. Cl. 345/212; 345/211; 345/89

(57) ABSTRACT

The present invention has been made in an effort to provide a circuit for generating driving voltages, a liquid crystal display, and a method of generating driving voltages having advantages that a plurality of driving voltages are not reduced so that desired grays are displayed and the contrast ratio is not deteriorated. For this purpose, driving voltages are generated using a battery voltage outputted from a battery of a mobile device according to an embodiment of the present invention. In this manner, by generating a source voltage VS and a common voltage Vcom using a battery voltage V_BAT, the reduced amounts of the source voltage VS and the common voltage Vcom are lessened, and therefore, voltages required by the specifications can be maintained. As a result, black is displayed more darkly or white is displayed more brightly, so that the contrast ratio C/R of a display device can be increased.

### CROSS-REFERENCE TO RELATED APPLICATION

This application claims priority to Korean Patent Application No. 10-2007-0013561 filed in the Korean Intellectual Property Office on Feb. 9, 2007, the entire contents of which are incorporated herein by reference.

### BACKGROUND OF THE INVENTION

(a) Technical Field

The present invention relates to driving voltages, and more particularly, to a circuit for generating driving voltages, a display device using the same, and a method of generating driving voltages.

(b) Discussion of the Related Art

A liquid crystal display (LCD) generally includes two display panels and a liquid crystal (LC) layer interposed therebetween and has dielectric anisotropy. A desired image is obtained by applying an electric field in the LC layer and regulating the electric field to adjust the transmittance of light passing through the LC layer. Among the LCDs, which are representative of portable flat panel displays (FPDS), a TFT-LCD using a thin film transistor (TFT) as a switching element is mainly used.

Such an LCD displays an image by applying a plurality of driving voltages. A driving voltage reduction occurs in an LCD due to its internal resistance. A plurality of driving voltages are generated by boosting or reducing an inputted voltage. Further, the driving voltages may become inadvertently reduced while passing through the various components of the LED. As a result, desired grays are not well displayed. This deteriorates the contrast ratio as well as the image.

### SUMMARY OF THE INVENTION

Exemplary embodiments of the present invention provide a circuit for generating driving voltages and an LCD having a plurality of driving voltages that are not reduced. Desired grays are displayed and a high contrast ratio is maintained. Driving voltages are generated using a battery voltage outputted from a battery of a mobile device.

An exemplary embodiment of the present invention provides a circuit for generating driving voltages. The circuit includes a regulator supplied with a battery voltage from a mobile device. A common voltage generator generates a common voltage from the battery voltage using a voltage outputted from the regulator. A source driving voltage generator generates a source voltage from the battery voltage using a voltage that is outputted from the regulator.

The common voltage generator may generate a VCOMH voltage representing a maximum value of the common voltage, and a VCOM Amp voltage representing a difference between the maximum value and a minimum value of the common voltage.

The source voltage generated at the source driving voltage generator may be applied to a gray voltage generator for generating a gray voltage.

The battery voltage may be used as a bias voltage of the source voltage and the common voltage.

The circuit for generating driving voltages may further include a gate voltage generator for generating a gate voltage using a voltage inputted from the regulator.

The regulator may be further supplied with a VCI voltage which is a driving voltage applied to a board in the mobile device.

The regulator may generate a VSS4 voltage which is a bias voltage for a minimum value of the common voltage by reducing the VCI voltage.

The gate voltage generated at the gate voltage generator may include a gate-on voltage and a gate-off voltage.

The gate-on voltage may be generated by boosting the VCI voltage, while the gate-off voltage may be generated by reducing the battery voltage.

The gate-on voltage may be generated by generating and then boosting a DDVDH voltage. The DDVDH voltage is generated and is then increased to twice as high as the VCI voltage and greater than the battery voltage.

Another exemplary embodiment of the present invention provides a display device. The display device includes a liquid crystal panel assembly. A plurality of gate lines and data lines are formed in a row direction and a column direction, respectively. A plurality of pixels, each including a switching element, and each connected to a gate line and a data line, are formed in a region defined by the intersection of the gate lines and the data lines. Each of the plurality of pixels further includes a liquid crystal capacitor connected to the switching element. The liquid crystal capacitor is connected to an output terminal of the switching element and to a common voltage. A gate driver supplies a gate voltage for driving the switching element to the gate line. A gray voltage generator generates a gray voltage corresponding to an applied data signal. A data driver applies the gray voltage to the data line. A driving voltage generator boosts a voltage according to a boost clock signal and generates the gate voltage and the common voltage based on the boosted voltage. A signal controller controls the liquid crystal panel assembly, the gate driver, the gray voltage generator, the data driver, and the driving voltage generator. A microprocessor unit (MPU) controls a mobile device and applies a battery voltage to the signal controller. The driving voltage generator receives the battery voltage and generates a driving voltage.

The driving voltage generator may include a regulator supplied with the battery voltage of the mobile device. A common voltage generator generates the common voltage from the battery voltage using a voltage that is outputted from the regulator. A source driving voltage generator generates a source voltage from the battery voltage using a voltage that is outputted from the regulator.

The common voltage generator may generate a VCOMH voltage representing a maximum value of the common voltage, and a VCOM Amp voltage representing a difference between the maximum value and a minimum value of the common voltage.

The source voltage generated at the source driving voltage generator may be applied to a gray voltage generator for generating a gray voltage.

The driving voltage generator may further include a gate voltage generator for generating a gate voltage using a voltage inputted from the regulator.

The regulator may be further supplied with a VCI voltage, which is a driving voltage applied to a board in the mobile device.

The regulator may generate a VSS4 voltage, which is a bias voltage for a minimum value of the common voltage, by reducing the VCI voltage.

The gate voltage generated at the gate voltage generator may include a gate-on voltage and a gate-off voltage.

The gate-on voltage may be generated by boosting the VCI voltage, while the gate-off voltage may be generated by reducing the battery voltage.

The gate-on voltage may be generated by generating and boosting a DDVDH voltage. The DDVDH voltage is increased to twice as high as the VCI voltage and greater than the battery voltage.

Another exemplary embodiment of the present invention provides a method of generating driving voltages. The method includes receiving a battery voltage from a battery of a mobile device. A source voltage and a common voltage are generated by reducing the battery voltage.

The battery voltage may be a bias voltage of the source voltage and the common voltage.

The generating of the source voltage and the common voltage by reducing the battery voltage may include generating the source voltage by reducing the battery voltage, and generating the common voltage by reducing the generated source voltage.

The common voltage may include a VCOMH voltage representing a maximum value of the common voltage and a VCOML voltage representing a minimum value of the common voltage. The VCOMH voltage may be generated by reducing the source voltage, while the VCOML voltage may be generated by reducing the VCOMH voltage.

In the step of receiving the battery voltage from the battery of the mobile device, a VCI voltage which is a driving voltage applied to a board in the mobile device may also be received in addition to the battery voltage.

The VCI voltage may be boosted to generate a gate-on voltage, and the battery voltage may be reduced to generate a gate-off voltage.

The source voltage may be generated after the gate-on voltage and the gate-off voltage are generated, and subsequently, the common voltage may be generated.

### BRIEF DESCRIPTION OF THE DRAWINGS

These and/or other aspects and features of the exemplary embodiments of the present invention are described below in conjunction with the accompanying drawings of which:

FIG. 1 is a block diagram of an LCD according to an exemplary embodiment of the present invention;

FIG. 2 is an equivalent circuit diagram of a pixel of an LCD according to an exemplary embodiment of the present invention;

FIG. 3 is a schematic diagram of an LCD according to an exemplary embodiment of the present invention;

FIG. 4 is a configuration diagram of a driving voltage generator according to an exemplary embodiment of the present invention;

FIG. 5 is a driving voltage generating relationship diagram according to an exemplary embodiment of the present invention;

FIG. 6 is a table illustrating a relationship between driving voltages according to an exemplary embodiment of the present invention; and

FIG. 7 is a table illustrating luminances of black and white and contrast ratios according to an exemplary embodiment of the present invention.

### DETAILED DESCRIPTION OF THE EMBODIMENTS

Exemplary embodiments of the present invention will be described more fully hereinafter with reference to the accompanying drawings. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

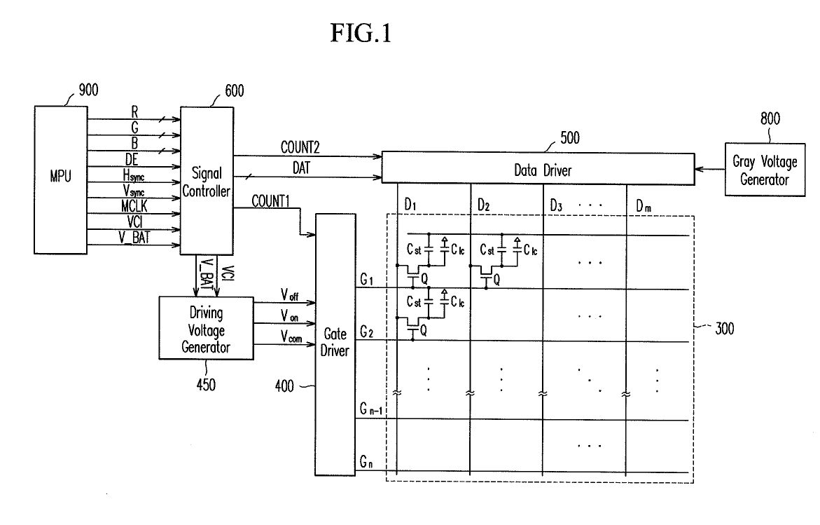

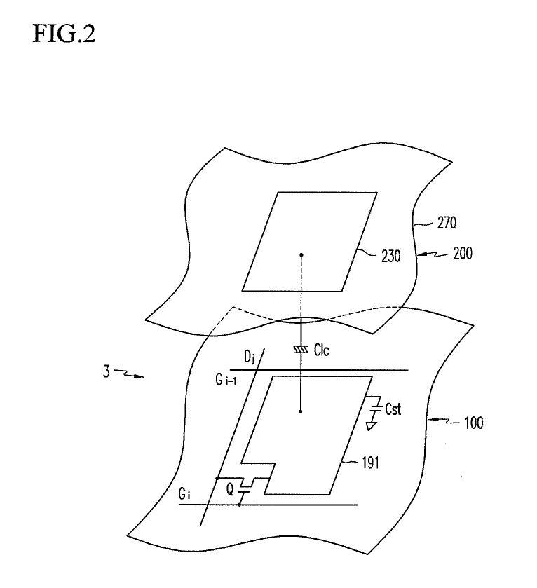

Firstly, an LCD according to an exemplary embodiment of the present invention will be described in detail with reference to FIG. 1 and FIG. 2.

FIG. 1 is a block diagram of an LCD according to an exemplary embodiment of the present invention, and FIG. 2 is an equivalent circuit diagram of a pixel of an LCD according to an exemplary embodiment of the present invention.

As shown in FIG. 1, an LCD according to an exemplary embodiment of the present invention includes an LC panel assembly 300, a gate driver 400, a data driver 500, a gray voltage generator 800 connected to the data driver 500, a driving voltage generator 450 connected to the gate driver 400, and a signal controller 600 for controlling the above elements. The signal controller 600 is supplied with image signals, control signals, and a battery voltage V_BAT from a microprocessor unit 900 (hereinafter referred to as an “MPU”) that controls a mobile device such as a mobile phone.

The LC panel assembly 300 includes a plurality of signal lines G₁-Gₙ and D₁-Dₘ, and a plurality of pixels PX connected to the signal lines G₁-Gₙ and D₁-Dₘ and arranged substantially in a matrix, as seen in the equivalent circuit diagram. Further, the LC panel assembly 300 includes lower and upper panels 100 and 200, respectively, facing each other and an LC layer 3 interposed therebetween, as seen in the structural view of FIG. 2.

The signal lines G₁-Gₙ and D₁-Dₘ include a plurality of gate lines G₁-Gₙ for transmitting gate signals (also referred to as “scanning signals”) and a plurality of data lines D₁-Dₘ for transmitting data signals. The gate lines G₁-Gₙ extend substantially in a row direction and are substantially parallel to each other, and the data lines D₁-Dₘ extend substantially in a column direction and are substantially parallel to each other.

Each pixel PX, for example the pixel PX connected to the i-th (i=1, 2, . . . , n) gate line Gᵢ and the j-th (j=1, 2, . . . , m) data line Dⱼ, includes a switching element Q connected to the signal lines Gᵢ and Dⱼ, and an LC capacitor C_{LC} and a storage capacitor C_{ST} connected to the switching element Q. The storage capacitor C_{ST} may be omitted.

The switching element Q, including a TFT, is a three-terminal element provided on the lower panel 100. The switching element Q includes a control terminal connected to the gate line Gᵢ, an input terminal connected to the data line Dⱼ, and an output terminal connected to the LC capacitor C_{LC} and the storage capacitor C_{ST}.

The LC capacitor C_{LC} includes a pixel electrode 191 provided on the lower panel 100 and a common electrode 270 provided on the upper panel 200 as two terminals, and the LC layer 3 interposed between the two electrodes 191 and 270 functions as a dielectric of the LC capacitor C_{LC}. The pixel electrode 191 is connected to the switching element Q, and the common electrode 270 is formed on the entire surface of the upper panel 200 and is supplied with a common voltage Vcom. Unlike FIG. 2, the common electrode 270 may be provided on the lower panel 100, and in this case, at least one of the two electrodes 191 and 270 may have a shape of a bar or a stripe.

The storage capacitor C_{ST}, functioning as an auxiliary capacitor for the LC capacitor C_{LC}, is formed by overlapping a separate signal line (not shown) which is provided on the lower panel 100 with the pixel electrode 191 via an insulator interposed therebetween. The separate signal line is supplied with a predetermined voltage such as a common voltage Vcom. Alternatively, the storage capacitor C_{ST} may be formed by overlapping the pixel electrode 191 with an upper previous gate line disposed directly thereabove via an insulator.

In order to implement color display, each pixel PX uniquely displays one of the primary colors (spatial division) or each pixel PX sequentially displays the primary colors in turn (temporal division) such that the spatial or temporal sum of the primary colors is recognized as a desired color. An example of a set of the primary colors includes the three additive primary colors of red, green, and blue. FIG. 2 shows an example of the spatial division in which each pixel PX includes a color filter 230 representing one of the primary colors in an area of the upper panel 200 facing the pixel electrode 191. Unlike FIG. 2, the color filter 230 may be provided on or under the pixel electrode 191 provided on the lower panel 100.

One or more polarizers (not shown) for polarizing light are attached on the outer surface of the LC panel assembly 300.

Referring to FIG. 1 again, the gray voltage generator 800 generates two sets of a plurality of gray voltages (or reference gray voltages) related to the transmittance of the pixels PX. Gray voltages of one set have a positive value with respect to the common voltage Vcom, while gray voltages of the other set have a negative value with respect to the common voltage Vcom.

The gate driver 400 is connected to the gate lines G₁-Gₙ in the LC panel assembly 300 and synthesizes a gate-on voltage Von and a gate-off voltage Voff to generate gate signals, which are applied to the gate lines G₁-Gₙ.

The gate-on voltage Von and the gate-off voltage Voff applied to the LC panel assembly 300 from the gate driver 400 are driving voltages generated at the driving voltage generator 450. Also, a common voltage Vcom is generated at the driving voltage generator 450 and applied to the LC panel assembly 300. The configuration of the driving voltage generator 450 will be described later.

The data driver 500 is connected to the data lines D₁-Dₘ of the LC panel assembly 300 and selects gray voltages supplied from the gray voltage generator 800 and then applies the selected gray voltages to the data lines D₁-Dₘ as data signals. However, in the case when the gray voltage generator 800 supplies only a predetermined number of reference gray voltages, rather than supplying voltages for all grays, the data driver 500 divides the reference gray voltages to generate gray voltages for all grays, from which data signals are selected.

The signal controller 600 controls the driving voltage generator 450, the gate driver 400, and the data driver 500.

Each of the driving devices 400, 450, 500, 600, and 800 mentioned above may be directly mounted on the LC panel assembly 300 in the form of at least one integrated circuit (IC) chip, may be mounted on a flexible printed circuit film (not shown) to be attached to the LC panel assembly 300 in a tape carrier package (TCP) form, or may be mounted on a separate printed circuit board (not shown). On the other hand, the driving devices 400, 450, 500, 600, and 800 may be integrated with the LC panel assembly 300 along with the signal lines G₁-Gₙ and D₁-Dₘ and the TFT switching elements Q. Moreover, the driving devices 400, 450, 500, 600, and 800 may be integrated into a single chip, and in this case, at least one of these devices or at least one circuit element forming these devices may be located outside the single chip.

Also, the MPU 900, which is a process unit for controlling a mobile device such as a mobile phone, supplies image signals R, G, and B, various input control signals DE, Hsync, Vsync, CLK, and VCI, and a battery voltage V_BAT to the signal controller 600. The VCI voltage is a driving voltage for driving a mobile device such as a mobile phone, and is applied to a board in the mobile device. The battery voltage V_BAT is a voltage outputted from a battery for supplying power in a mobile device such as a mobile phone.

The operation of such an LCD will now be described in detail.

The signal controller 600 receives input image signals R, G, and B and input control signals for controlling the display of the image signals R, G, and B from the MPU 900. The input control signals include, for example, a vertical synchronization signal Vsync, a horizontal synchronization signal Hsync, a main clock signal MCLK, a data enable signal DE, a VCI voltage, and a battery voltage V_BAT.

On the basis of the input control signals and the input image signals R, G, and B, the signal controller 600 appropriately processes the input image signals R, G, and B to be suitable for the operating conditions of the LC panel assembly 300 and generates gate control signals CONT1 and data control signals CONT2. Then, the signal controller 600 transmits the gate control signals CONT1 to the gate driver 400 and transmits the processed data image signals DAT and the data control signals CONT2 to the data driver 500. Meanwhile, the VCI voltage and the battery voltage V_BAT are transmitted to the driving voltage generator 450.

The gate control signals CONT1 include a scanning start signal STV for instructing to start scanning, and at least one gate clock signal CPV for controlling the output time of a gate-on voltage Von. The gate control signals CONT1 may further include an output enable signal OE for defining the duration time of the gate-on voltage Von.

The data control signals CONT include a horizontal synchronization start signal STH for indicating a start to transmit image data DAT for a row of pixels PX, a load signal LOAD for instructing to apply data signals to the data lines D₁-Dₘ, and a data clock signal HCLK. The data control signals CONT may further include an inversion signal RVS for reversing the polarity of a data signal with respect to a common voltage Vcom (hereinafter, “the polarity of the data signal with respect to the common voltage Vcom” is referred to as “the polarity of the data signal”).

Responding to the data control signals CONT2 from the signal controller 600, the data driver 500 sequentially receives digital image signals DAT for a row of pixels PX, selects gray voltages corresponding to the respective digital image signals DAT, converts the digital image signals DAT into analog data signals, and then applies the analog data signals to the corresponding data lines D₁-Dₘ.

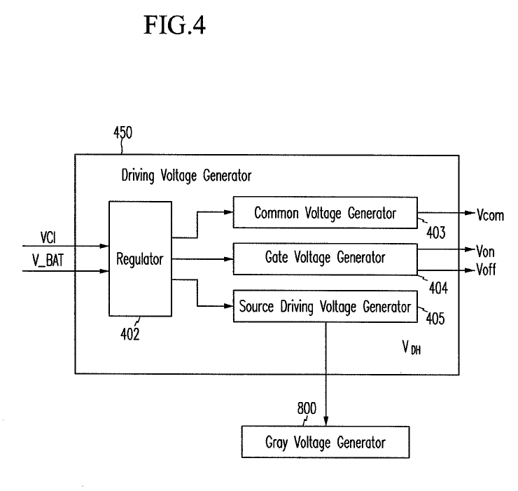

The driving voltage generator 450 supplied with the VCI voltage and the battery voltage V_BAT generates a common voltage Vcom, a gate-on voltage Von, and a gate-off voltage Voff using a regulator 402 (FIG. 4). Among them, the gate-on voltage Von and the gate-off voltage Voff are transmitted to the gate driver 400, and the common voltage Vcom is applied to the common electrode in the LC panel assembly 300.

The gate driver 400 applies the gate-on voltage Von to the gate lines G₁-Gₙ in response to the gate control signals CONT1 from the signal controller 600, thereby turning on the switching elements Q connected to the gate lines G₁-Gₙ. Then, data signals applied to the data lines D₁-Dₘ are applied to the corresponding pixels PX through the turned-on switching elements Q.

A difference between the voltage of a data signal applied to a pixel PX and the common voltage Vcom appears as a charge voltage of the LC capacitor C_{LC}, for example, a pixel voltage. The arrangement of the LC molecules varies depending on the intensity of the pixel voltages, and accordingly, the polarization of light passing through the LC layer 3 changes. As a result, the change in the polarization causes a change in transmittance of light by polarizers attached to the LC panel assembly 300.

By repeating this procedure by a unit of a horizontal period (which is also denoted as “1H” and is equal to one period of the horizontal synchronization signal Hsync and the data enable signal DE), all gate lines G₁-Gₙ are sequentially supplied with the gate-on voltage Von, thereby applying the data signals to all pixels PX to display an image for a frame.

When the next frame starts after one frame, the inversion signal RVS applied to the data driver 500 is controlled such that the polarity of the data signals applied to each pixel PX is reversed to be opposite to the polarity of the previous frame (which is referred to as “frame inversion”).

Here, even in one frame, the polarity of the data signals flowing in a data line may vary (for example, row inversion or dot inversion) or the polarities of the data signals applied to a pixel row may be different from each other (for example, column inversion or dot inversion) in accordance with the characteristics of the inversion signal RVS.

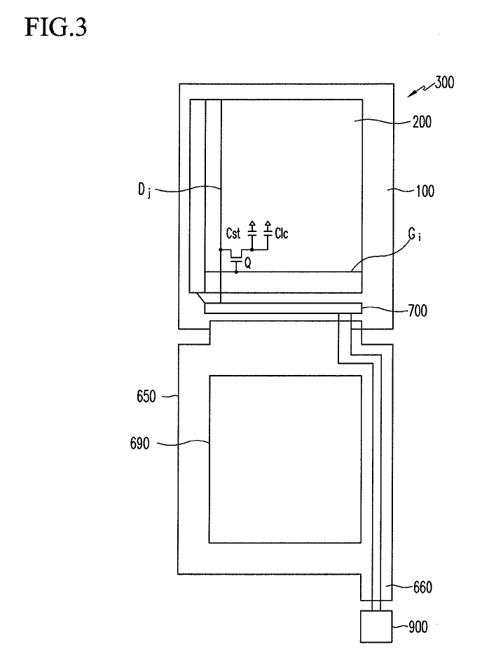

FIG. 3 is a schematic diagram of an LCD according to an exemplary embodiment of the present invention.

As shown in FIG. 3, an LCD according to an exemplary embodiment of the present invention includes an LC panel assembly 300, an integration chip 700 mounted on the lower panel 100 of the LC panel assembly 300, and a flexible printed circuit (FPC) film 650 attached to an edge of the lower panel of the LC panel assembly 300 for applying signals to the integration chip 700.

First, the integration chip 700 is formed by integrating the driving devices 400, 450, 500, 600, 800 (shown in FIG. 1) into an IC. Since a mobile device such as a mobile phone has a small LC panel assembly 300, the amount of data to be processed is relatively small and the size of the mobile device is also small, which causes a lack of space where a plurality of chips can be mounted. Thus, the integration chip 700 can be desirably used.

The FPC 650 is folded in an assembled state, and includes an opening 690 that exposes the lower surface of the LC panel assembly 300 when it is folded. One end of the FPC 650 is attached to the lower panel 100 of the LC panel assembly 300. The other end of the FPC 650 includes a protrusion 660. The protrusion 660 functions as an input section to which a signal is applied from the MPU 900, and a plurality of signal lines for electrically connecting the integration chip 700 and the MPU 900 are provided.

The LC panel assembly 300 and the FPC 650 are attached to each other by an anisotropic conductive layer (not shown) for electrical connection thereof.

Hereinafter, a method of generating driving voltages by the driving voltage generator 450 of such an LCD will be described in detail.

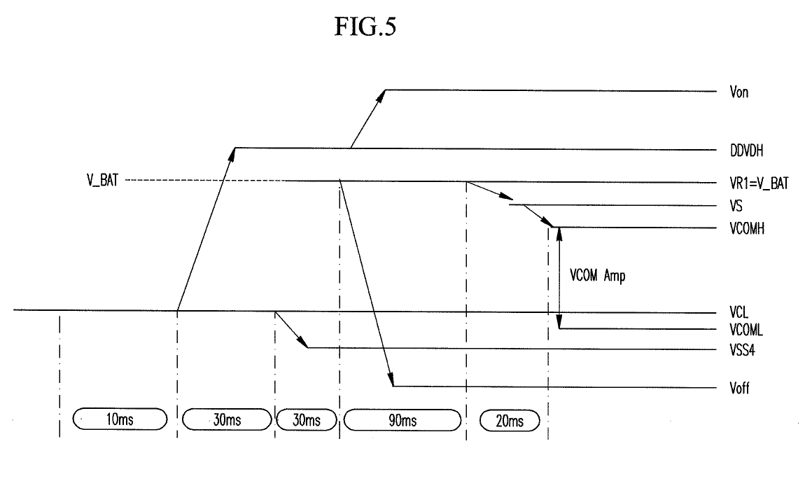

FIG. 4 is a configuration diagram of a driving voltage generator according to an exemplary embodiment of the present invention, and FIG. 5 is a driving voltage generating relationship diagram according to an exemplary embodiment of the present invention.

The driving voltage generator 450 according to an exemplary embodiment of the present invention converts a VCI voltage and a battery voltage V_BAT, which are applied from the signal controller 600, into a needed value through the regulator 402 and outputs the converted voltages to a common voltage generator 403, a gate voltage generator 404, and a source driving voltage generator 405. The common voltage generator 403, the gate voltage generator 404, and the source driving voltage generator 405 generate respective driving voltages using voltages inputted from the regulator 402.

The regulator 402 generates voltages to be inputted to the common voltage generator 403, the gate voltage generator 404, and the source driving voltage generator 405 using the VCI voltage and the battery voltage V_BAT. Here, a bias voltage may also be generated to be applied to the common voltage generator 403, the gate voltage generator 404, and the source driving voltage generator 405.

The common voltage generator 403 generates a VCOMH voltage and a VCOM Amp voltage for generating a common voltage Vcom. The VCOMH voltage is a voltage when the common voltage Vcom is at a high level, and the VCOM Amp is a voltage determining the difference between the VCOMH voltage and the VCOML voltage (a voltage when the common voltage Vcom is at a low level). In this manner, a VCOMH voltage and a VCOML voltage are generated and applied to the common electrode 270 of the LC panel assembly 300.

The VCOMH voltage is generated by reducing the battery voltage V_BAT. Meanwhile, the VCOML voltage is generated by reducing the VCOMH voltage by as much as the VCOM Amp. This is illustrated in FIG. 5 and will be described later.

The gate voltage generator 404 generates a gate-on voltage Von and a gate-off voltage Voff. The gate-on voltage Von is generated by boosting the VCI voltage. Meanwhile, the gate-off voltage Voff is generated by reducing the battery voltage V_BAT. This is illustrated in FIG. 5 and will be described later.

In the meantime, the source driving voltage generator 405 generates a source voltage VS. The source voltage VS is transmitted to the gray voltage generator 800 and is divided using a row of resistors to generate respective gray voltages. The source voltage VS is generated by reducing the battery voltage V_BAT.

The relationship between the VCI voltage and battery voltage V_BAT inputted into the driving voltage generator 450 and the driving voltages generated by the driving voltage generator 450 is illustrated with a diagram in FIG. 5. FIG. 5 illustrates which voltages are reduced or boosted to generate the corresponding voltages.

Voltages inputted into the driving voltage generator 450 are the VCI voltage and the battery voltage V_BAT. Here, the VCI voltage is boosted or reduced to be used, and the battery voltage V_BAT is directly used as the VR1 voltage, which is a bias voltage of the source voltage VS. The applied battery voltage V_BAT depends on the state of the battery, and in general, it operates in the range of 4.2V to 3.7V, while the mobile device is turned off with a message indicating a low battery when the battery voltage V_BAT is 3.6V or less.

The DDVDH voltage is a voltage that is increased to twice as high as the VCI voltage in FIG. 5. In the meantime, the VR1 voltage, as a bias voltage, prevents the source voltage VS and the VCOMH voltage from being generated to be greater than the VR1 voltage, wherein the DDVDH voltage is greater than the VR1 voltage in consideration of the battery voltage V_BAT.

Meanwhile, the VSS4 voltage, which is a bias voltage of the VCOML voltage, prevents the VCOML voltage from being generated at a level less than the VSS4 voltage.

An inputted VCI voltage is doubled to generate a DDVDH voltage through the regulator 402. The DDVDH voltage is generated after 10 ms from initialization. As a result, the maximum value of the VR1 voltage is determined, and accordingly, the maximum values of the source voltage VS and the VCOMH voltage are also determined.

When 30 ms passes after the DDVDH voltage is generated, the VCI voltage is reduced to generate a VSS4 voltage. Thus, the minimum value of the VCOML voltage is also determined.

When 30 ms passes after the VSS4 voltage is generated, that is, after 60 ms since the DDVDH voltage is generated, the DDVDH voltage is boosted to generate a gate-on voltage Von. Around the time when a gate-on voltage Von is generated, the VR1 voltage is reduced to generate a gate-off voltage Voff. The gate-on voltage Von and the gate-off voltage Voff are generated at the gate voltage generator 404.

When 90 ms passes after the gate-on voltage Von and the gate-off voltage Voff are generated, the VR1 voltage is reduced to generate a source voltage VS. Here, the VR1 voltage is a bias voltage of the source voltage VS. The source voltage VS is generated at the source driving voltage generator 405.

When 20 ms passes after the source voltage VS is generated, a VCOMH voltage and a VCOML voltage are sequentially generated. The VCOMH voltage is generated by reducing the generated source voltage VS, and the VCOML voltage is generated by reducing the VCOMH voltage by as much as VCOM Amp. The VCOMH voltage and the VCOML voltage are generated at the common voltage generator 403.

FIG. 5 shows the time differences taken when voltages are boosted and reduced. Such time differences may prevent different voltages from overlapping when generated, and the time differences may be set variously according to various exemplary embodiments.

The signal controller 600 may further include many elements performing functions such as processing and generating various control signals for driving a general LCD and processing inputted image data.

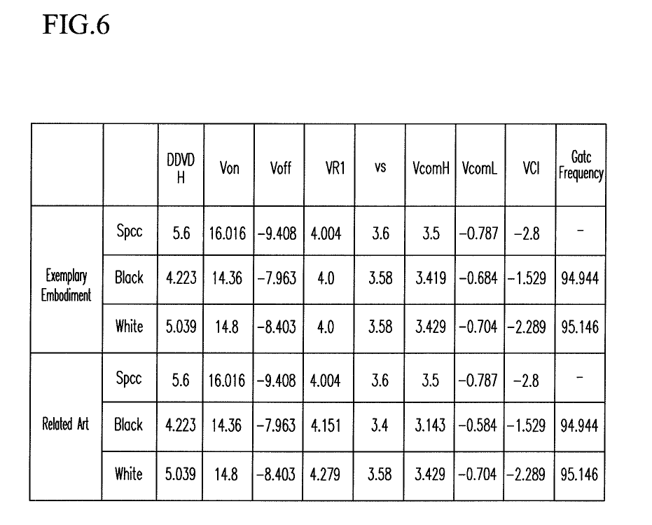

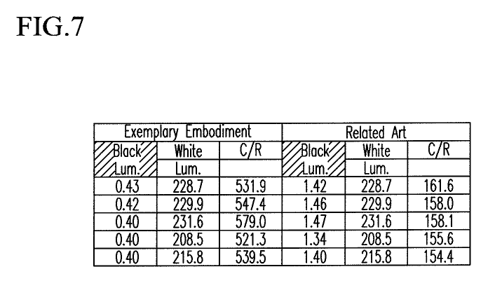

FIG. 6 is a table illustrating a relationship between driving voltages according to an exemplary embodiment of the present invention, and FIG. 7 is a table illustrating luminances of black and white and contrast ratios according to an exemplary embodiment of the present invention.

In FIG. 6 and FIG. 7, an exemplary embodiment of the present invention in which a source voltage VS is generated using a battery voltage V_BAT is compared with the related art in which only a VCI voltage is applied and then boosted or reduced to generate a source voltage VS. The values in FIG. 6 and FIG. 7 are results of experiments with a display device in a normally white mode.

FIG. 6 illustrates the voltage values of the respective voltages. An LCD has a luminance that is determined by a voltage difference between voltages applied to pixel electrodes and the common electrode. Based on this, it can be known that there is a large difference between the specified values and the source voltage VS and VCOMH voltage as black is displayed. However, there is no large difference from the specified value according to an exemplary embodiment of the present invention, while there is a large difference from the specified value according to the related art.

Due to such differences, it can be known that there are differences in the luminance of black and the contrast ratio C/R in FIG. 7. That is, when black is displayed, relatively low luminance is represented according to an exemplary embodiment of the present invention, while relatively high luminance is represented according to the related art. As a result, there is a large difference between their contrast ratios C/R even though the luminance of white is the same.

In a normally black mode, the luminance of white is increased such that the contrast ratio C/R is also increased according to an exemplary embodiment of the present invention.

As described above, by generating a source voltage VS and a common voltage Vcom using a battery voltage V_BAT, the reduced amounts of the source voltage VS and the common voltage Vcom are lessened, and therefore voltages required by the specifications can be maintained. As a result, black is displayed more darkly and/or white is displayed more brightly, so that the contrast ratio C/R of a display device can be increased.

While exemplary embodiments of the present invention have been described in connection with the drawings, it is to be understood that the invention is not limited to the disclosed exemplary embodiments, but, on the contrary, is intended to cover various modifications and equivalent arrangements.

What is claimed is:

1. A circuit for generating driving voltages, which comprises:
a regulator supplied with a battery voltage of a mobile device;
a common voltage generator for generating a common voltage from the battery voltage using a voltage that is outputted from the regulator; and
a source driving voltage generator for generating a source voltage from the battery voltage using a voltage that is outputted from the regulator.

2. The circuit for generating driving voltages of claim 1, wherein the common voltage generator generates a VCOMH voltage representing a maximum value of the common voltage and a VCOM Amp voltage representing a difference between the maximum value and a minimum value of the common voltage.

3. The circuit for generating driving voltages of claim 1, wherein the source voltage generated at the source driving voltage generator is applied to a gray voltage generator for generating a gray voltage.

4. The circuit for generating driving voltages of claim 1, wherein the battery voltage is used as a bias voltage of the source voltage and the common voltage.

5. The circuit for generating driving voltages of claim 1, further comprising a gate voltage generator for generating a gate voltage using a voltage inputted from the regulator.

6. The circuit for generating driving voltages of claim 5, wherein the regulator is further supplied with a VCI voltage which is a driving voltage applied to a board in the mobile device.

7. The circuit for generating driving voltages of claim 6, wherein the regulator generates a VSS4 voltage which is a bias voltage for a minimum value of the common voltage, by reducing the VCI voltage.

8. The circuit for generating driving voltages of claim 6, wherein the gate voltage generated at the gate voltage generator includes a gate-on voltage and a gate-off voltage.

9. The circuit for generating driving voltages of claim 8, wherein the gate-on voltage is generated by boosting the VCI voltage, and the gate-off voltage is generated by reducing the battery voltage.

10. The circuit for generating driving voltages of claim 9, wherein the gate-on voltage is generated by generating a DDVDH voltage, which is a voltage that is increased to twice as high as the VCI voltage and is greater than the battery voltage, and by boosting the DDVDH voltage.

11. A display device comprising:
a liquid crystal panel assembly wherein a plurality of gate lines and a plurality of data lines are formed in a row direction and a column direction, respectively;
a plurality of pixels, each including a switching element connected to a gate line and a data line in a region defined by the gate lines and the data lines intersecting each other are formed, each of the plurality of pixels further includes a liquid crystal capacitor connected to the switching element, and the liquid crystal capacitor is connected to an output terminal of the switching element and to a common voltage;
a gate driver supplying a gate voltage for driving the switching element to the gate line;
a gray voltage generator generating a gray voltage corresponding to an applied data signal;
a data driver applying the gray voltage to the data line;
a driving voltage generator boosting a voltage according to a boost clock signal and generating the gate voltage and the common voltage based on the boosted voltage;
a signal controller for controlling the liquid crystal panel assembly, the gate driver, the gray voltage generator, the data driver, and the driving voltage generator; and
a microprocessor unit (MPU) for controlling a mobile device and applying a battery voltage to the signal controller,
wherein the driving voltage generator receives the battery voltage and generates a driving voltage.

12. The display device of claim 11, wherein the driving voltage generator comprises:
a regulator supplied with the battery voltage of the mobile device;
a common voltage generator for generating the common voltage using a voltage that is outputted from the regulator using the battery voltage; and
a source driving voltage generator for generating a source voltage using a voltage that is outputted from the regulator using the battery voltage.

13. The display device of claim 12, wherein the common voltage generator generates a VCOMH voltage representing a maximum value of the common voltage and a VCOM Amp voltage representing a difference between the maximum value and a minimum value of the common voltage.

14. The display device of claim 12, wherein the source voltage generated at the source driving voltage generator is applied to the gray voltage generator.

15. The display device of claim 12, wherein the driving voltage generator further comprises a gate voltage generator for generating the gate voltage using a voltage inputted from the regulator.

16. The display device of claim 15, wherein the regulator is further supplied with a VCI voltage which is a driving voltage applied to a board in the mobile device.

17. The display device of claim 16, wherein the regulator generates a VSS4 voltage which is a bias voltage for a minimum value of the common voltage by reducing the VCI voltage.

18. The display device of claim 16, wherein the gate voltage generated at the gate voltage generator includes a gate-on voltage and a gate-off voltage.

19. The display device of claim 18, wherein the gate-on voltage is generated by boosting the VCI voltage, and the gate-off voltage is generated by reducing the battery voltage.

20. The display device of claim 19, wherein the gate-on voltage is generated by generating a DDVDH voltage, which is a voltage that is increased to twice as high as the VCI voltage and is greater than the battery voltage, and by boosting the DDVDH voltage.

21. A method of generating driving voltages, comprising:
receiving a battery voltage from a battery of a mobile device; and
generating a source voltage and a common voltage by reducing the battery voltage.

22. The method of claim 21, wherein the battery voltage is a bias voltage of the source voltage and the common voltage.

23. The method of claim 21, wherein the generating of the source voltage and the common voltage by reducing the battery voltage comprises:
generating the source voltage by reducing the battery voltage; and
generating the common voltage by reducing the generated source voltage.

24. The method of claim 23, wherein the common voltage includes a VCOMH voltage representing a maximum value of the common voltage and a VCOML voltage representing a minimum value of the common voltage; and
the VCOMH voltage is generated by reducing the source voltage, and the VCOML voltage is generated by reducing the VCOMH voltage.

25. The method of claim 21, wherein in the step of receiving the battery voltage from the battery of the mobile device,
a VCI voltage, which is a driving voltage applied to a board in the mobile device, is received in addition to the battery voltage.

26. The method of claim 25, wherein the VCI voltage is boosted to generate a gate-on voltage, and the battery voltage is reduced to generate a gate-off voltage.

27. The method of claim 26, wherein the source voltage is generated after the gate-on voltage and the gate-off voltage are generated, and the common voltage is generated after the source voltage is generated.
